(19) United States
(12) Patent Application Publication
(10) Pub. No.: US 2012/0110946 A1
(43) Pub. Date: May 10, 2012

(54) Lattice Structure

(75) Inventors: Kamal Daas, Bergschenhoek (NL); Doron Livnat, Rotterdam (NL)

(73) Assignee: ProDelta Investments B.V., Rotterdam (NL)

(21) Appl. No.: 13/125,544

(22) PCT Filed: Oct. 14, 2009
(86) PCT No.: PCT/EP09/07383

§ 371 Date: Apr. 21, 2011

(30) Foreign Application Priority Data
Oct. 22, 2008 (DE) 20 2008 014 059.5

(51) Int. Cl. B66C 23/68; E04H 12/10; E04B 1/344

(52) U.S. Cl. 52/646; 212/299

(57) ABSTRACT

The present invention relates to a lattice structure which is adjustable between a condition folded in and a condition folded out, wherein the lattice structure includes longitudinally extending props which in the condition of the lattice structure folded out are connected with each other by obliquely extending struts, wherein the obliquely extending struts are directly or indirectly pivotally arranged on the longitudinally extending props and wherein at least one of the obliquely extending struts has a first portion and a second portion which are connected with each other in an articulated manner such that their angle to each other becomes smaller on folding in the lattice structure.

The present invention relates to a lattice structure which is adjustable between a condition folded in and a condition folded out, wherein the lattice structure includes longitudinally extending props which in the condition of the lattice structure folded out are connected with each other by obliquely extending struts, wherein the obliquely extending struts are directly or indirectly pivotally arranged on the longitudinally extending props.

From the prior art, so-called lattice structures are known, which include longitudinally extending props which in the condition of the lattice structure folded out are connected with each other by obliquely extending struts. The arrangement of the struts is solved such that the distance of the props extending in longitudinal direction of the lattice structure is reducible and increasable, so that the lattice structure can be folded in and folded out.

It is the object underlying the present invention to develop a lattice structure as mentioned above to the effect that the same has a comparatively simple construction and nevertheless provides for easy folding in and folding out.

This object is solved by a lattice structure with the features of claim 1.

Accordingly, it is provided that at least one of the obliquely extending struts, preferably a plurality or all of these obliquely extending struts have a first portion and a second portion which are connected with each other in an articulated manner such that the angle to each other becomes smaller on folding in the lattice structure.

The obliquely extending struts thus can be designed for example in the form of a toggle lever whose one lever is directly or indirectly pivotally connected with a longitudinally extending prop and whose other lever is directly or indirectly pivotally connected with another longitudinally extending prop. In principle, it is also conceivable to design the obliquely extending struts with more than one joint, which however involves a correspondingly more expensive construction.

In a further aspect of the invention it is provided that all of the obliquely extending struts have a first portion and a second portion which are connected with each other in an articulated manner such that the angle to each other becomes smaller on folding in the lattice structure.

At least some of the obliquely extending struts can extend crosswise and be arranged minor-symmetrically to each other relative to an axis extending in transverse direction of the lattice structure. Correspondingly, the direction of movement of the obliquely extending struts on folding in the lattice structure also is mirror-symmetrical to each other, which means that on folding in the lattice structure the joint of one of the obliquely extending struts, which connects the two portions, is moved in one direction of the lattice structure and that of another strut obliquely extending crosswise with the same is moved in the other direction of the lattice structure.

In a further aspect of the invention it is provided that at least one of the obliquely extending struts is articulated to a sleeve which is firmly or movably arranged on the longitudinally extending props. A comparatively simple construction is obtained when the sleeve is firmly arranged on the longitudinally extending prop or when the first and/or second portions are pivotally arranged on fixed points of the longitudinally extending props.

Moving the longitudinally extending props towards each other on folding the lattice structure together becomes possible due to the fact that the obliquely extending props consist of at least two portions which are connected with each other in an articulated manner.

Preferably, the first portion and the second portion of the obliquely extending struts are configured such that the same have different lengths. If the obliquely extending struts are struts which consist of two portions it can thus be provided that the joint connecting these two portions is not arranged centrally in the strut, but offset thereto, in particular facing towards one of the end regions.

In a further aspect of the invention it is provided that the first portion and/or the second portion of the obliquely extending struts includes first arresting means by means of which the portion or portions can be fixed at second arresting means which are arranged on the longitudinally extending props or on a component arranged thereon. The second arresting means can be designed such that the first arresting means of several, preferably two obliquely extending struts can be fixed at a second arresting means. Thus, it is conceivable for example that the longitudinally extending props or components arranged thereon, such as a sleeve, include second arresting means by means of which the first arresting means of two obliquely extending struts can be fixed.

The arresting means for example can include a movably arranged bolt which extends through corresponding bores of the obliquely extending struts and of the longitudinally extending props or components arranged thereon.

In addition, in the condition of the lattice structure folded out there can be provided transversely extending struts provided with a joint, which connect the longitudinally extending props with each other. These transversely extending struts serve to increase the stability of the lattice structure and in addition can be provided with actuating means by which the folding in and/or folding out of the lattice structure is facilitated or effected.

The invention furthermore relates to a crane which is characterized in that it consists of one or more lattice structures according to any of claims 1 to 10 or includes at least one such lattice structure.

Further details and advantages of the invention will be explained in detail with reference to an embodiment illustrated in the drawing, in which:

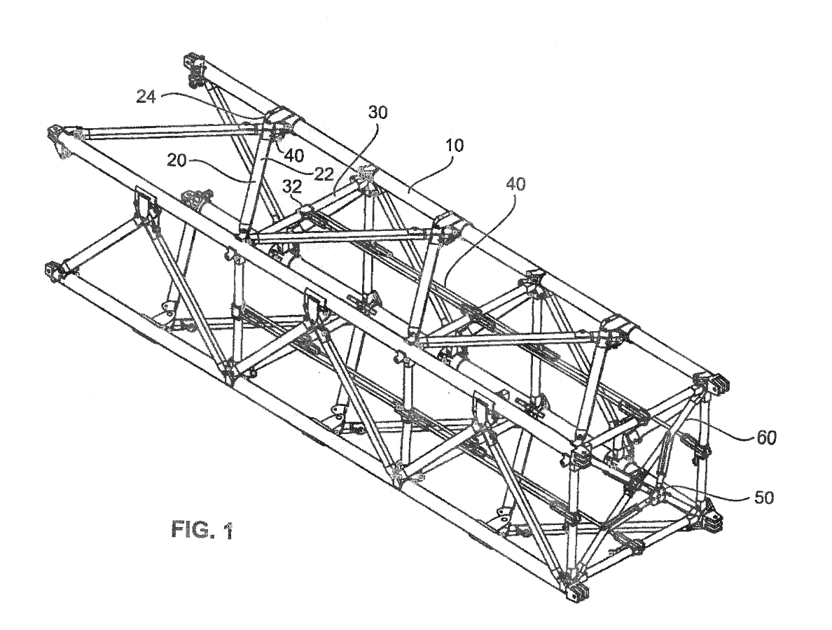

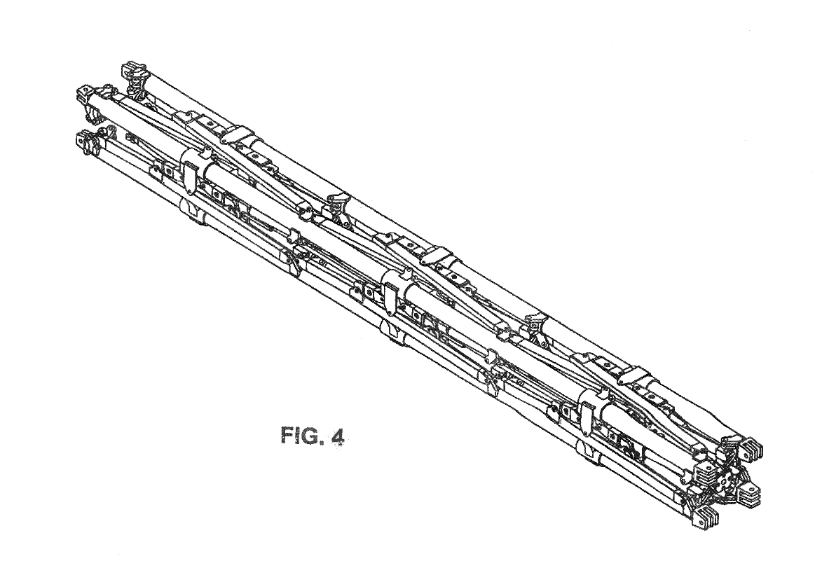

FIG. 1-FIG. 5: show perspective and side views, respectively, of the lattice structure of the invention in the condition folded out, in the condition folded in, and in intermediate conditions,

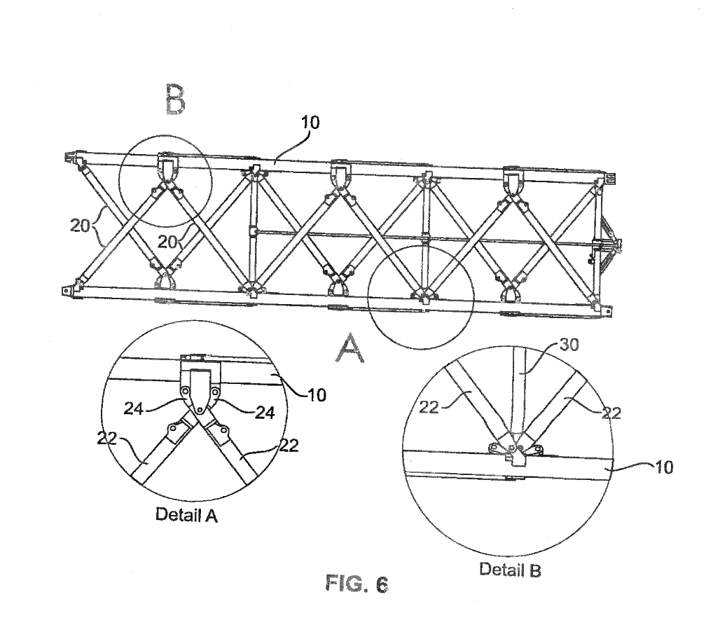

FIG. 6: shows a side view of the lattice structure of the invention with detail representations,

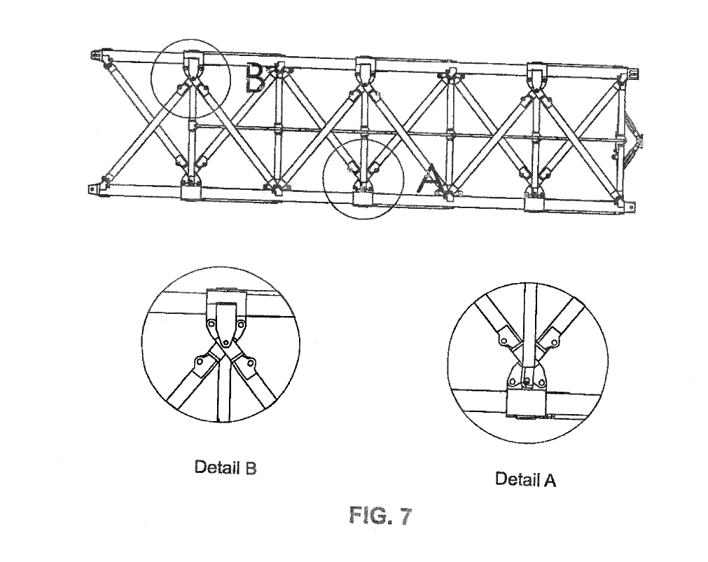

FIG. 7: shows a side view of the lattice structure in another embodiment with detail representations, and

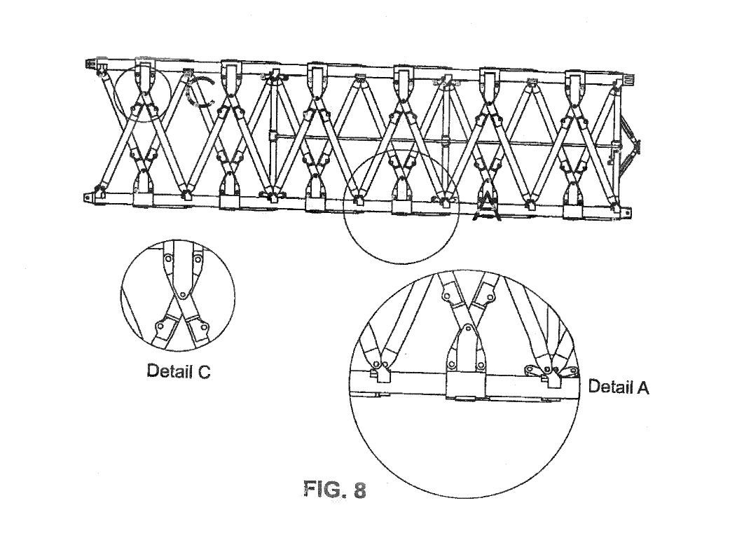

FIG. 8: shows a side view of the lattice structure in a further embodiment with detail representations.

FIGS. 1 to 5 show the lattice structure in accordance with the present invention in different conditions.

FIG. 1 shows the lattice structure in the condition folded out.

In the embodiment shown here it consists of four longitudinally extending props 10 which in cross-section form the corners of a rectangle or square. In principle, other cross-sectional shapes are also conceivable. These longitudinally extending props 10 are connected with each other by struts 20 extending longitudinally in the condition folded out as shown in FIG. 1. The obliquely extending struts 20 each consist of a first portion 22 and of a second portion 24. The first portion 22 is designed longer than the second portion 24. The first portion 22 is articulated to a longitudinally extending prop 10. The second portion 24 is articulated to the adjacent longitudinally extending prop 10. Both portions are connected with each other by a joint 40 which provides for the two portions 22, 24 being pivotable relative to each other.

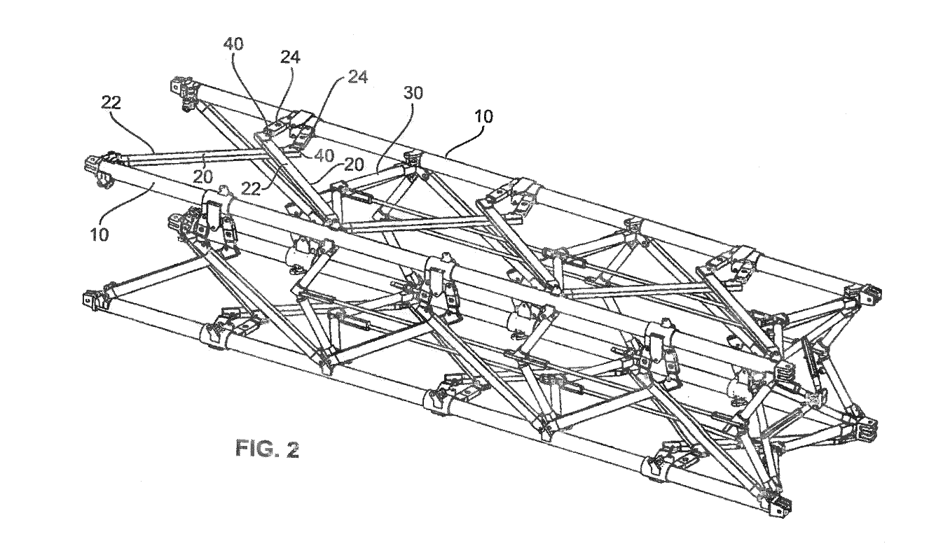

As can furthermore be taken from FIG. 1, two adjacent obliquely extending struts 20 each extend crosswise, wherein the crossing point is shifted on folding the lattice structure together proceeding from the condition shown in FIG. 1, as can be taken from FIGS. 2 to 5. Thus, the crossing point is not fixed, but is obtained corresponding to the position of the obliquely extending struts 20 relative to each other.

As can furthermore be taken from FIG. 1, two adjacent obliquely extending struts 20 each are mirror-symmetrically arranged and designed relative to a plane extending in transverse direction of the lattice structure.

Two of the adjacent props 10 extending in longitudinal direction each are furthermore connected by struts 30 which in the condition of the lattice structure folded out extend linearly and in transverse direction to the lattice structure. These struts 30 include a joint 32 by means of which they can be folded in and out. Reference numeral 40 designates a linkage which each connects two transversely extending struts 30 adjacent in longitudinal direction of the lattice structure. These linkages ensure a synchronous sequence of movements of the transversely extending struts 30 on folding together and on folding out the lattice structure.

Reference numeral 50 designates an actuating element which is connected with struts 60 which extend crosswise and are diagonally arranged in an end-side end face of the lattice structure. By means of the actuating element, folding together and folding apart the lattice structure can be effected.

The obliquely extending struts 30 and the transversely extending struts 20 each are arranged in outer surfaces of the lattice structure.

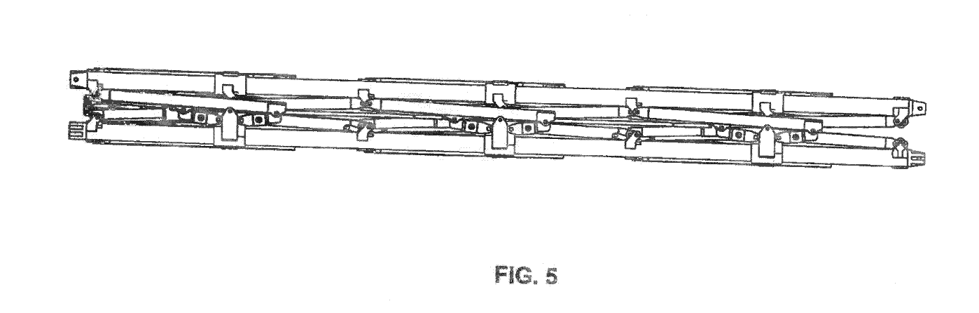

If the lattice structure is to be folded together proceeding from the position shown in FIG. 1, the condition according to FIG. 2 initially is obtained. Hence it can be seen that the obliquely extending struts 20 buckle on folding together. Due to the mirror-symmetrical arrangement of two adjacent struts 20 that joint 40 moves which each connects the first portion 22 with a second portion 24 of the struts, according to FIG. 2 for one of the obliquely extending struts 20 to the left, while at the same time the joint 40 of the adjacent strut 20 moves to the right. During the folding together, the two second (shorter) portions 24 move away from each other, until they finally extend parallel or approximately parallel to the longitudinally extending props 10 or rest against the same in the condition completely folded together as shown in FIG. 5. However, this is not absolutely necessary, i.e. a non-parallel arrangement is also conceivable. On folding together, the longer first portions 22 are moved towards the longitudinally extending prop 10, to which they are articulated and which is adjacent to the longitudinally extending prop 10 to which the second portions 24 of the struts 20 are articulated.

As can furthermore be taken from FIG. 2, buckling of the transversely extending struts 30 also occurs on folding the lattice structure together.

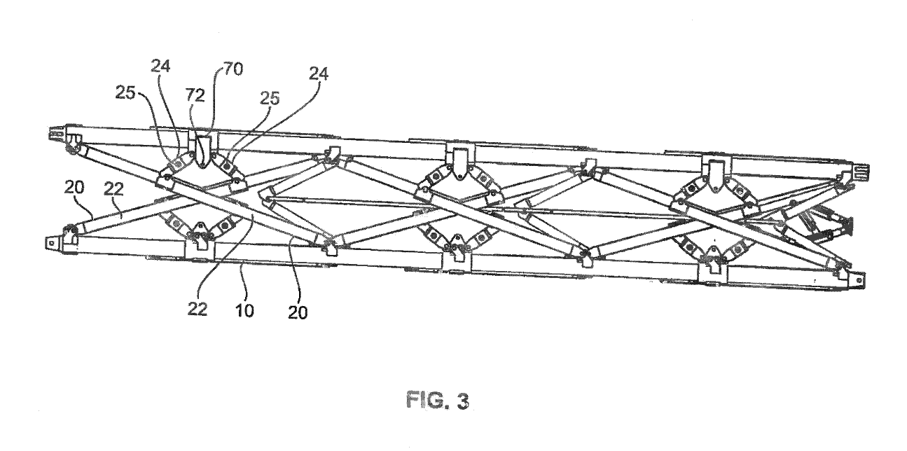

FIGS. 3 to 5 show the lattice structure in further conditions, during the process of folding in, and clearly illustrate that during folding in the second portions 24 are moved towards one of the longitudinally extending props 10 and the first portions 22 are moved towards the adjacent longitudinally extending prop 10.

As can furthermore be taken from FIG. 1, the first portions 22 and the second portions 24 are not directly pivotally arranged on the props 10 extending in longitudinal direction, but on a sleeve seated thereon or on some other fastening element. This sleeve is shown in FIG. 3 by way of example with the reference numeral 70. In its region facing away from the longitudinally extending prop it includes a bore 72. In addition, the second portions 24 of the adjacent struts 20 likewise include bores 25 which are arranged such that in the condition of the lattice structure folded out according to FIG. 1 they are aligned with the bore 72 of the sleeve 70. In this condition, a bolt or the like can be put through the bores 25 and 72, which leads to the fact that the lattice structure is arrested in its condition shown in FIG. 1. If the lattice structure is to be folded together proceeding from this condition, the bolt is removed to such an extent that a movement of the obliquely extending struts relative to the longitudinally extending props 10 is possible.

FIG. 6 shows the lattice structure of the invention again in a schematic side view and detail representations of the details A and B. From FIG. 6 it can be taken that the arresting means described with reference to FIG. 3 are arranged opposite each other on two adjacent longitudinally extending props 10. The fastening point succeeding in longitudinal direction of the lattice structure is formed by a simple articulation without such arresting possibility. Said simple articulation of the obliquely extending struts hence is effected in alternation with an articulation of these struts with arresting possibility. FIG. 6 illustrates that the transversely extending struts 30 only are arranged in the vicinity of every second articulation region of the obliquely extending struts. In contrast to this, FIG. 7 shows an embodiment in which the transversely extending struts 30 are arranged at the level of each articulation region of the obliquely extending struts 20 at the props 10 extending in longitudinal direction. FIG. 8 finally illustrates a further embodiment from which it can be taken that the density, i.e. the distance of the obliquely extending struts to each other also can be made larger or smaller than is shown in FIG. 7. This can be necessary when a particularly high stability of the lattice structure is required.

1. A lattice structure which is adjustable between a folded in condition and a folded out condition, comprising:
longitudinally extending props which in the folded out condition of the lattice structure are connected with each other by obliquely extending struts, wherein the obliquely extending struts are directly or indirectly pivotally arranged on the longitudinally extending props and wherein at least one of the obliquely extending struts has a first portion and a second portion which are connected with each other in an articulated manner such that their angle to each other becomes smaller on folding in the lattice structure.

2. The lattice structure according to claim 1, wherein all of the obliquely extending struts have a first portion and a second portion which are connected with each other in an articulated manner such that their angle to each other becomes smaller on folding in the lattice structure.

3. The lattice structure according to claim 1, wherein at least some of the obliquely extending struts extend crosswise and are arranged mirror-symmetrically to each other relative to a plane extending in a transverse direction of the lattice structure.

4. The lattice structure according to claim 1, wherein at least one of the obliquely extending struts is articulated to a sleeve which is firmly or movably arranged on the longitudinally extending props.

5. The lattice structure according to claim 1, wherein in the folded in condition of the lattice structure, the first portion and/or the second portion of the obliquely extending struts extends parallel or approximately parallel or at an angle to the longitudinally extending props.

6. The lattice structure according to claim 1, wherein the first portion and the second portion of the obliquely extending struts have different lengths.

7. The lattice structure according to claim 1, wherein the first portion and/or the second portion of the obliquely extending struts includes a first arresting element by which the portion or portions are fixable at second arresting elements which are arranged on the longitudinally extending props.

8. The lattice structure according to claim 7, wherein the second arresting elements are designed such that the first arresting elements of several obliquely extending struts are fixable at the second arresting elements.

9. The lattice structure according to claim 7, wherein the first or the second arresting elements are formed by bores and/or by bolts received in the bores.

10. The lattice structure according to claim 7, wherein in that in the folded out condition of the lattice structure, transversely extending struts are provided with a joint, which connect the longitudinally extending props with each other.

11. (canceled)

12. The lattice structure according to claim 1, wherein the first portion and/or the second portion of the obliquely extending struts includes a first arresting element by which the portion or portions are fixable at second arresting elements which are arranged on a component arranged on the longitudinally extending props.

13. A crane, comprising:
a lattice structure which is adjustable between a folded in condition and a folded out condition, the lattice structure including longitudinally extending props which in the folded out condition of the lattice structure are connected with each other by obliquely extending struts, wherein the obliquely extending struts are pivotally arranged on the longitudinally extending props and wherein at least one of the obliquely extending struts has a first portion and a second portion which are connected with each other in an articulated manner such that their angle to each other becomes smaller on folding in the lattice structure.

14. The crane according to claim 13, wherein all of the obliquely extending struts have a first portion and a second portion which are connected with each other in an articulated manner such that their angle to each other becomes smaller on folding in the lattice structure.

15. The crane according to claim 13, wherein at least some of the obliquely extending struts extend crosswise and are arranged mirror-symmetrically to each other relative to a plane extending in a transverse direction of the lattice structure.

16. The crane according to claim 15, wherein at least one of the obliquely extending struts is articulated to a sleeve which is firmly or movably arranged on the longitudinally extending props.

17. The crane according to claim 16, wherein in the folded in condition of the lattice structure, the first portion and/or the second portion of the obliquely extending struts extends parallel or approximately parallel or at an angle to the longitudinally extending props.

18. The crane according to claim 17, wherein the first portion and the second portion of the obliquely extending struts have different lengths.

19. The lattice structure according to claim 18, wherein the first portion and the second portion of the obliquely extending struts includes a first arresting element by which the portion or portions are fixable at second arresting elements which are arranged on the longitudinally extending props.

20. A crane, comprising:
a lattice structure which is adjustable between a folded in condition and a folded out condition, the lattice structure including longitudinally extending props which in the folded out condition of the lattice structure are connected with each other by obliquely extending struts, wherein the obliquely extending struts are pivotally arranged on the longitudinally extending props and wherein each of the obliquely extending struts has a first portion and a second portion which are connected with each other in an articulated manner such that their angle to each other becomes smaller on folding in the lattice structure, wherein the obliquely extending struts are in the form of a toggle lever whose one lever is pivotally connected with a longitudinally extending prop and whose other lever is pivotally connected with another longitudinally extending prop.
